(19) United States
(12) Patent Application Publication
(10) Pub. No.: US 2006/0077623 A1
(43) Pub. Date: Apr. 13, 2006

(54) Display device

(75) Inventor: Han-Min Yeh, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Hannspree, Inc.

(21) Appl. No.: 11/018,801

(22) Filed: Dec. 21, 2004

(30) Foreign Application Priority Data
Oct. 7, 2004 (TW) 93215921

(51) Int. Cl. G06F 1/16

(52) U.S. Cl. 361/681

(57) ABSTRACT

A display device. A display device comprises a body and a supporting member. The body comprises a front side and a rear side. The supporting member is rotatably connected to the body, and supports the body. When the supporting member is in the first position, the supporting member serves as a stand such that the body is at an upright position. When the supporting member is in the second position, the supporting member serves as a handle for hanging the body.

### BACKGROUND

The invention relates to display devices, and in particular to display devices with a supporting member functioning as a handle and a stand.

Display devices, such as TVs, liquid crystal displays, and notebook screens, have become thin and light and have a small footprint due to innovation. Not only are size and quality required, multiple functions such as connecting to a computer, a TV, or other imaging electronic devices are also important for customers. Other than quality and functionality, convenience and delicate appearance are also required.

Conventional display devices, however, are still inconvenient to carry when traveling.

### SUMMARY

Display devices are provided. An exemplary embodiment of a display device comprises a body and a supporting member. The body comprises a front side and a rear side. The supporting member is rotatably connected to the body, and supports the body. When the supporting member is in the first position, the supporting member serves as a stand such that the body is at an upright position. When the supporting member is in the second position, the supporting member serves as a handle for hanging the body.

The supporting member comprises a curved portion, forming a gap with the body. When the supporting member is in the first position, the curved portion is located under the rear side of the body to enhance the stability of the supporting member being a stand.

The supporting member further comprises at least one skidproof portion, disposed on the curved portion.

The supporting member is tube-shaped.

The supporting member comprises metal.

The supporting member comprises skidproof material.

The display device comprises a liquid crystal display (LCD), a TV, a plasma display panel (PDP), or an organic light emitting display (OLED).

### DESCRIPTION OF THE DRAWINGS

Display devices can be more fully understood by reading the subsequent detailed description in conjunction with the examples and references made to the accompanying drawings, wherein:

FIG. 1 is a schematic perspective view of an embodiment of a display device in a first position;

FIG. 2 is a side view of the display device in a first position;

FIG. 3 is a schematic perspective view of an embodiment of a display device in a second position.

### DETAILED DESCRIPTION

Display devices are provided. An embodiment of the display devices of the invention is described in the following.

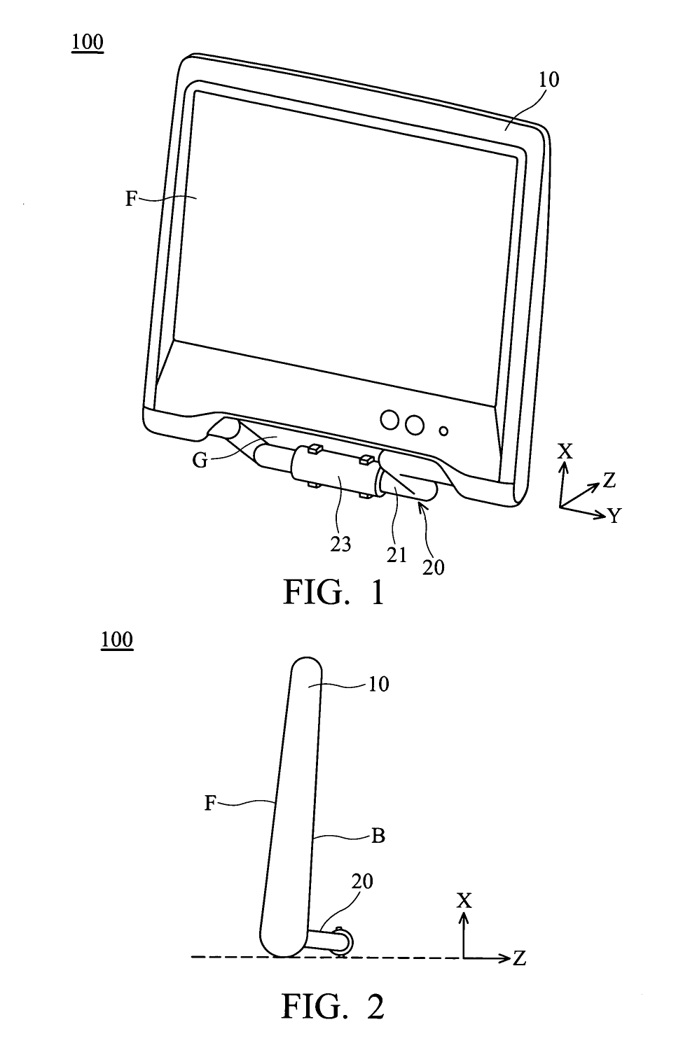

FIG. 1 is a schematic perspective view of an embodiment of a display device 100 in a first position. FIG. 2 is a side view of the display device 100 in a first position.

The display device 100 comprises a body 10 and a supporting member 20. The supporting member 20 is rotatably connected to the body 10, and supports the body 10. When the supporting member 20 is in the first position, the supporting member 20 serves as a stand such that the body 10 is at an upright position. Since only the supporting member 20 occupies the desk area, more desk space is saved.

As shown in FIGS. 1 and 2, the body 10 comprises a front side F and a rear side B, and the supporting member 20 comprises a curved portion 21, formed a gap G with the body 10. In an embodiment of the display device, the curved portion 21 is located in the middle of the supporting member 20. When the body 10 is upright, the curved portion 21 is located under the rear side B of the body 10, and supports the body 10. The supporting member 20 further comprises a skidproof portion 23, disposed on the middle portion of the curved portion 21. The supporting member 20 comprises metal or plastic, and is tube-shaped.

In another embodiment of the invention, the supporting member 20 comprises skidproof material.

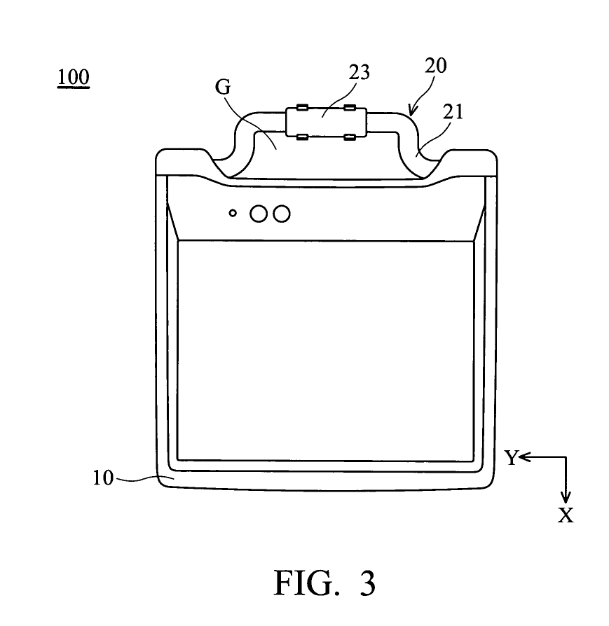

FIG. 3 is a schematic perspective view of an embodiment of the display device 100 in a second position. When the supporting member 20 is in the second position, the supporting member 20 serves as a handle for hanging the body 10 such that users can carry the display device 100 conveniently.

The supporting member comprises a curved portion, forming a gap with the body. When the supporting member is in the first position, the curved portion is located under the rear side of the body to enhance the stability of the supporting member being a stand.

The display device 100 is given as an example of the invention. The mentioned embodiment is applicable to other types of display devices such as TVs, plasma display panels (PDPs), organic light emitting displays (OLEDs), and others.

As described above, a display device is disclosed such that the display device can be upright, easy to carry when traveling, or be hung on a wall. The display device with a simplified structure and assembly can be viewed at any place and any angle without occupying additional space on a work desk.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a body, comprising a front side and a rear side; and
a supporting member, rotatably connected to the body, and supports the body; wherein when the supporting member is in the first position, the supporting member serves as a stand such that the body is at an upright position; when the supporting member is in the second position, the supporting member serves as a handle for hanging the body.

2. The display device as in claim 1, wherein the supporting member comprises a curved portion, forming a gap with the body; when the supporting member is in the first position, the curved portion is located under the rear side of the body to enhance the stability of the supporting member being a stand.

3. The display device as in claim 2, wherein the supporting member further comprises at least one skidproof portion, disposed on the curved portion.

4. The display device as in claim 1, wherein the supporting member is tube-shaped.

5. The display device as in claim 1, wherein the supporting member comprises metal.

6. The display device as in claim 1, wherein the supporting member comprises skidproof material.

7. The display device as in claim 1, wherein the display device comprises a liquid crystal display.

8. The display device as in claim 1, wherein the display device comprises a television.

9. The display device as in claim 1, wherein the display device comprises a plasma display panel.

10. The display device as in claim 1, wherein the display device comprises an organic light emitting display.
